(19) United States
(12) Patent Application Publication
(10) Pub. No.: US 2008/0147496 A1
(43) Pub. Date: Jun. 19, 2008

(54) SYSTEM AND METHOD FOR PROVIDING PROMOTIONS

(75) Inventors: Debasis Bal, Bangalore (IN); Gopi Subramanian, Bangalore (IN); Srikanth Rajagopalan, Bangalore (IN)

Correspondence Address: GENERAL ELECTRIC COMPANY;GLOBAL RESEARCH, PATENT DOCKET RM. BLDG. K1-4A59, NISKAYUNA, NY, 12309, US

(73) Assignee: GENERAL ELECTRIC COMPANY, Schenectady, NY (US)

(21) Appl. No.: 11/612,843

(22) Filed: Dec. 19, 2006

(51) Int. Cl. G06Q 30/00; G06Q 40/00

(52) U.S. Cl. 705/14

(57) ABSTRACT

A technique is provided for delivering promotions to a consumer. The technique includes receiving a transaction card data from a terminal over a communication channel on presentation of a transaction card at the terminal, performing an authentication of the transaction card data, sending a promotional data containing one or more promotions to the terminal over the communication channel, and writing the promotional data on the transaction card via a card read/write device.

### BACKGROUND

The invention relates generally to a technique of providing promotions to a consumer and, more particularly, to a technique of providing promotions to a consumer via a transaction card.

Transaction cards have become ubiquitous in the fields of consumer and retail finance. There are various types of transaction cards such as magnetic stripe cards, RFID cards, optical cards, smart cards and so forth which may be used as debit cards, credit cards, PLCC cards, bank cards, loyalty cards, store cards, or dual cards. Typically, these transaction cards are being used as a transaction device or media. For example, as shown in FIG. 1, the current business process involves swiping a transaction card on a card reader for payment approval once the billing is done for the products being purchased. Information embedded in the transaction card is transmitted from the point of sale (POS) to a merchant bank through the Internet or a financier's network. Once the information is verified for relevant details, the transaction is approved. The approval comes back from the merchant bank to the point of sale terminal. The card reader then generates a transaction slip for being authorized by the consumer. Finally, the POS terminal generates a bill via a bill printer attached to the POS terminal.

After the transaction is captured and recorded, transaction card bill is prepared and sent to consumers at periodic intervals. Additionally, potential consumers are identified for certain marketing or promotional offers via back end analytics processes with the objective of increasing sales and revenue. These customized marketing or promotional offers along with various other marketing or promotional offers are then sent out to the consumers by email, printed postal mail, notices, or similar such paper means. Thus, customization and promotions are being currently managed through mailing campaigns of discount coupons that can be exchanged at POS, and similar other means.

However, the mailing process limits the customization that can be done for each individual consumer. Additionally, these promotions are seldom used and therefore ineffective since the location and timing of the consumer receiving the promotion is different from the place where it can be used (e.g. the store or POS). Moreover, the consumers have to keep track of these notifications or depend on the retailers to avail those offers. All these factors lead to inefficiency and make the promotional offers less effective.

It is therefore desirable to provide an efficient and effective technique for delivering marketing or promotional offers to the consumer so as to increase the sales and revenue.

### BRIEF DESCRIPTION

Briefly, in accordance with one aspect of the technique, a system is provided for delivering promotions to a consumer. The system includes a transaction bank server configured to send promotional data containing one or more promotions to a terminal over a communication channel. The terminal includes a card read/write device configured to write the promotional data on a transaction card.

In accordance with another aspect of the technique, a method is provided for delivering promotions to a consumer. The method provides for receiving a transaction card data from a terminal over a communication channel on presentation of a transaction card at the terminal, performing an authentication of the transaction card data, sending a promotional data containing one or more promotions to the terminal over the communication channel, and writing the promotional data on the transaction card via a card read/write device. Systems and computer programs that afford such functionality may be provided by the present technique.

In accordance with an additional aspect of the technique, a method is provided for delivering promotions to a consumer. The method provides for sending a transaction card data to a transaction bank server over a communication channel on presentation of a transaction card at the terminal, receiving a promotional data containing one or more promotions from the transaction bank server over the communication channel upon an authentication of the transaction card data by the transaction bank server, and writing the promotional data on the transaction card via a card read/write device. Here again, systems and computer programs affording such functionality may be provided by the present technique.

### DRAWINGS

These and other features, aspects, and advantages of the present invention will become better understood when the following detailed description is read with reference to the accompanying drawings in which like characters represent like parts throughout the drawings, wherein:

FIG. 1 is a schematic of a traditional business process for carrying out transactions through a transaction card;

FIG. 2 is a schematic of a system for delivering promotions or offers to the consumers in accordance with aspects of the present technique;

FIGS. 3 and 4 are a flowchart illustrating exemplary business process for delivering promotions or offers to the consumer in accordance with aspects of the present technique; and

FIG. 5 is a flowchart illustrating exemplary business process for displaying promotions or offers written on the transaction card of the consumer in accordance with aspects of the present technique.

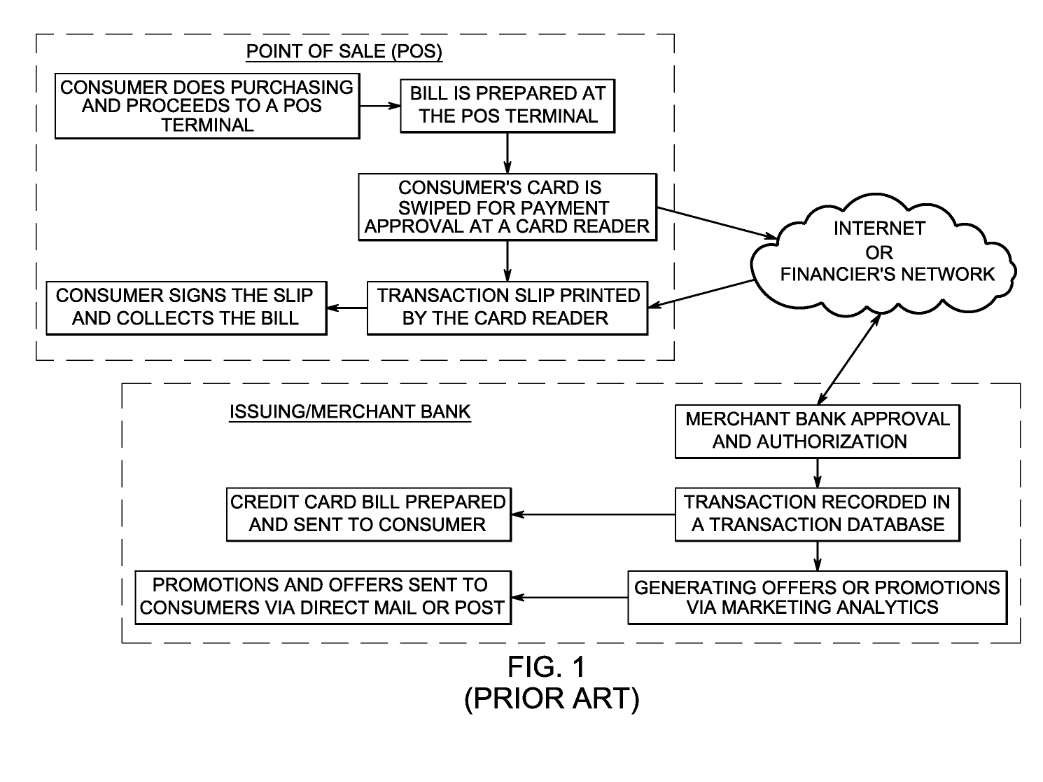

### DETAILED DESCRIPTION

The present techniques are generally directed to providing marketing and/or promotional offers to a consumer and to delivering the same to the consumer. Such promotion and delivery techniques may be useful in a variety of contexts, such as retail outlets, banking companies, airlines industries, hotel industries, and others. Though the present discussion provides examples in context of retail outlets and banking companies, one of ordinary skill in the art will readily apprehend that the application of these techniques in other contexts, such as for airlines or hotel industries, is well within the scope of the invention.

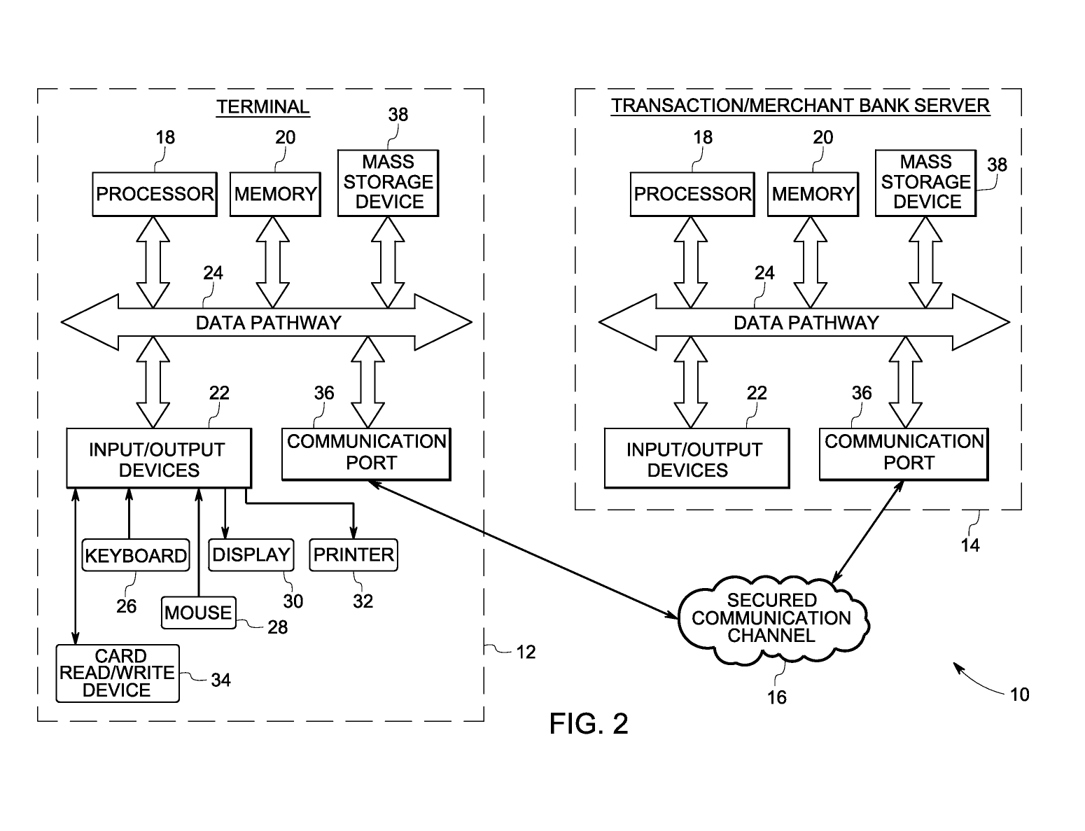

Referring now to FIG. 2, a schematic diagram of an exemplary system 10 for delivering promotions or offers to the consumers is illustrated in accordance with aspects of the present technique. The system 10 includes a terminal 12 in communication with a transaction bank server 14 via a secured communication channel 16. It should be noted that the terminal may be a POS terminal, a transaction terminal, a kiosk, a portable device, an ATM, or a computer terminal. The secured communication channel may be a wired or a wireless communication network such as Internet, local area network (LAN), wide area network (WAN), transaction bank network and so forth. Alternatively, the secure communication channel 16 may take the form of a portable memory device that may be coupled to either of the terminal 12 or the transaction bank server 14 for transferring the information between the two. It should be noted that the transmission of information between the terminal 12 and the transaction bank server may be in real time or in batch mode. The terminal 12 and the transaction server 14 may generally include a processor 18, a memory 20, and input/output devices 22 connected via a data pathway (e.g., buses) 24.

The processor 18 accepts instructions and data from the memory 20 and performs various data processing functions of the terminal 12 and the transaction bank server 14. These data processing functions may include extracting one or more promotions from the promotional data at the terminal end, analyzing consumer behavior via an analytics engine at transaction bank server end, authenticating and authorizing the received data, executing instructions, and so forth. The processor 18 includes an arithmetic logic unit (ALU) that performs arithmetic and logical operations, and a control unit that extracts instructions from memory 20 and decodes and executes them, calling on the ALU when necessary. The memory 20 stores a variety of data received from the terminal 12, transaction bank server 14, and input/output devices 22. The data may include, for example, transaction card data, transaction data, transaction approval data, and promotional data related to the consumer. The memory generally includes a random-access memory (RAM) and a read-only memory (ROM); however, there may be other types of memory such as programmable read-only memory (PROM), erasable programmable read-only memory (EPROM) and electrically erasable programmable read-only memory (EEPROM). Also, the memory preferably contains an operating system, which executes on the processor. The operating system performs basic tasks that include recognizing input, sending output to output devices, keeping track of files and directories and controlling various peripheral devices. The information in the memory 20 might be conveyed to a human user through the input/output devices 22, the data pathway 24, or in some other suitable manner.

The input/output devices 22 may include a keyboard 26 and a mouse 28 that enables a user to enter data and instructions into the terminal 12 and the transaction bank server 14, a display device 30 that enables the user to view the available information, and a printer 32 that enables the user to print any data for his reference. Additionally, the input/output devices 22 at the terminal 12 may further include a card read/write device 34 configured to read information from a transaction card and to write information on the transaction card when the transaction card is swiped or presented to the terminal 12.

The terminal 12 and the transaction bank server 14 may further include a communication port 36 such as a telephone, cable or wireless modem; a network card such as an Ethernet adapter, local area network (LAN) adapter, integrated services digital network (ISDN) adapter, or Digital Subscriber Line (DSL) adapter; a USB port; IEEE 1394 port; and so forth, that enables the terminal 12 and the transaction bank server 14 to access each other over the secured communication channel 16. The terminals 12 and the transaction bank server 14 may also include a mass storage device 38 to allow the terminal 12 and the transaction bank server 14 to retain large amounts of data permanently. The mass storage device 38 may include all types of disk drives such as floppy disks, hard disks and optical disks, as well as tape drives that can read and write data onto a tape that could include digital audio tapes (DAT), digital linear tapes (DLT), or other magnetically coded media. The above-described terminal 12 and the transaction bank server 14 may take the form of a hand-held digital computer, personal digital assistant computer, notebook computer, personal computer, workstation, mini-computer, mainframe computer or supercomputer.

In the illustrated embodiment, the transaction card data embedded in the transaction card is read via the card read/write device 34 upon presentation of the transaction card at the terminal 12. The transaction card data 12 along with any transaction data is then transmitted from the terminal 12 to the transaction bank server 14 over the communication channel 16. As will be appreciated by one skilled in the art, the transaction bank server 14 is configured to receive the transaction card data (comprising consumer identification data) and/or the transaction data from the terminal 12, authenticate the transaction card data by verifying relevant details, authorize the transaction data upon authentication, and send a transaction approval data to the terminal 12. The transaction bank server 14 is further configured to capture details of a consumer along with details of the transaction performed by the respective consumer in a transaction database. A transaction card bill may be generated periodically and sent to each consumer based on the transactions performed by the respective consumer. Additionally, the transaction bank server 14 is configured to send promotional data comprising one or more promotions to the terminal 12 over the communication network 16 in accordance with aspects of the present technique. Alternatively, a promoter or merchandiser having a tie up with the merchant/transaction bank may be able to directly send the promotional data to the terminal 12.

The terminal 12 is configured to receive the promotional data and/or transaction approval data from the transaction bank server 14 and to write the promotional data on the transaction card via the card read/write device 34. Alternatively, the terminal 12 may be configured to extract the one or more promotions from the promotional data via the processor 18 and display the extracted promotions to the consumer as a selectable choice via the display device 30 coupled to the terminal 12. The selected promotions may then be written on the transaction card or printed by the terminal 12 via a printer 32 coupled to the terminal 12. Additionally, the display device 30 may be used to display the one or more promotions already written on the transaction card. Again, the terminal 12 may be configured to generate a printed coupon containing the promotional offers written on the transaction card. It should be noted that, in certain embodiments, the consumer may view the promotions on his/her transaction card, compare it against the one or more promotions being offered to him and may update the promotions on his/her transaction card with the ones available to him. In certain embodiments, the consumer may be automatically alerted about the new or existing promotions available to him through message alert on his mobile device or PDA. In particular, the consumer may receive such alerts when he is in vicinity of the promoter or merchandiser offering the respective promotions. As will be appreciated by one skilled in the art, the location of the mobile device or PDA (and hence the consumer) may be determined via any know or conceivable tracking techniques employing GPS, TV, TV-GPS, GSM, radio frequency (rf), and/or wireless network signals.

As will be appreciated by one skilled in the art, the one or more promotions may be customized for each consumer based on consumer's behavior and interest. The transaction bank server may perform analysis on each consumer's behavior based on his/her current and/or past transaction data via an analytics engine to generate the one or more customized promotions. The analysis may be performed periodically or in real time. The customized marketing and promotional offers for a specific consumer can be stored in a promotion database. The transaction bank server 14 may then send these customized marketing or promotional offers along with various other marketing or promotional offers to the terminal 12 for being written on the transaction card or for being displayed to the consumer as a selectable choice. Additionally, in certain embodiments, the transaction bank server 14 may maintain a consumer account for each consumer in the promotion database to store the one or more promotions associated with him/her. The consumer may access the associated account online to view the one or more promotions available to him or her through the terminal either via transaction card or via login information (user id and password). The consumer may then select the desired promotions for being written on his/her transaction card in real time or during any subsequent presentation of the card at the terminal. As will be appreciated by one skilled in the art, in certain embodiments, the consumer may use his mobile device or computer terminal to write the selected promotions on his/her transaction card via a card read/write device installed in or coupled to the mobile device or the computer terminal.

As will be appreciated by one skilled in the art, the transaction card may include any card having a data storage medium. For example, the transaction card may include a magnetic stripe card, a RFID card, an optical card, a contact or contactless smart card and so forth. These cards may be used as a debit card, a credit card, a PLCC card, a bank card, a loyalty card (for facilitating loyalty based promotions carried out by a specific retailer or promoter), reward card (for facilitating reward points based promotions generally carried out by a retailer or transaction bank), and so forth. It should be noted that the information such as promotional data may be written on one of the available read/write tracks of the magnetic stripe card. In one embodiment, the available read/write track may be track 3 of the magnetic stripe card. The promotional data may include one or more promotions such as a discount coupon, a cash back offer, a product discount, a credit card APR discount, a reward point based promotion, a loyalty point based promotion and so forth. As will be appreciated by one skilled in the art, the one or more promotions may be uniquely encoded in a pre-specified format to generate the promotional data via any known or developed encoding schemes before being sent to the terminal. Additionally, any type of personalized/dynamic information related to consumer may be written on the available read/write tracks of the magnetic stripe card. It should be noted that such personalized/dynamic information may be personal or useable information related to the cardholder and may be static or dynamic in nature. Such personalized/dynamic information may include a customized promotion offered to the consumer, blood group of the consumer, health information of the consumer, driving license number of the consumer, passport number of the consumer, security related information of the consumer and so forth.

As will be appreciated by one skilled in the art, a variety of techniques may be employed to deliver promotional or marketing offers to the consumers through his/her transaction card, to display the offers written on the transaction card, or to display the offers available to the consumer for being written on the transaction card. In particular, as will be appreciated by those of ordinary skill in the art, control logic and/or automated routines for performing the techniques and steps described herein may be implemented by the system 10, either by hardware, software, or combinations of hardware and software. For example, suitable code may be accessed and executed by the processor 18 to perform some or all of the techniques described herein. Similarly application specific integrated circuits (ASICs) configured to perform some or all of the techniques described herein may be included in the processor 18.

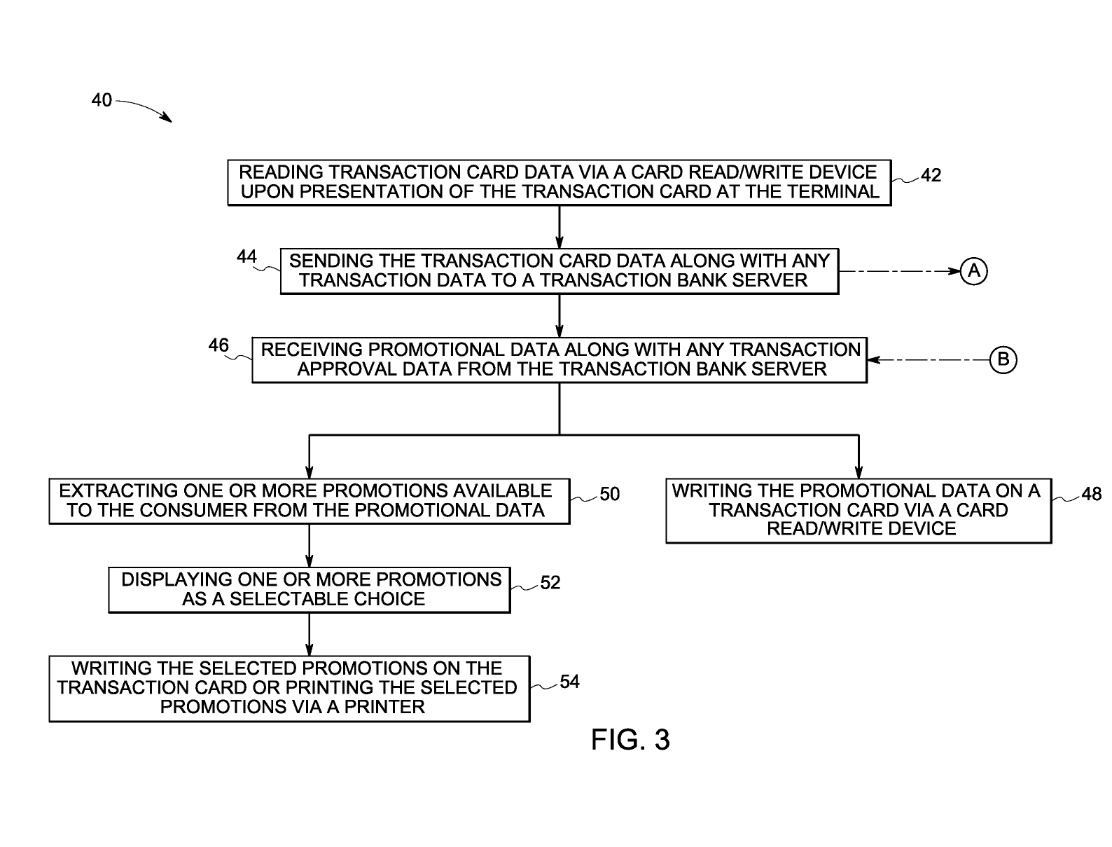

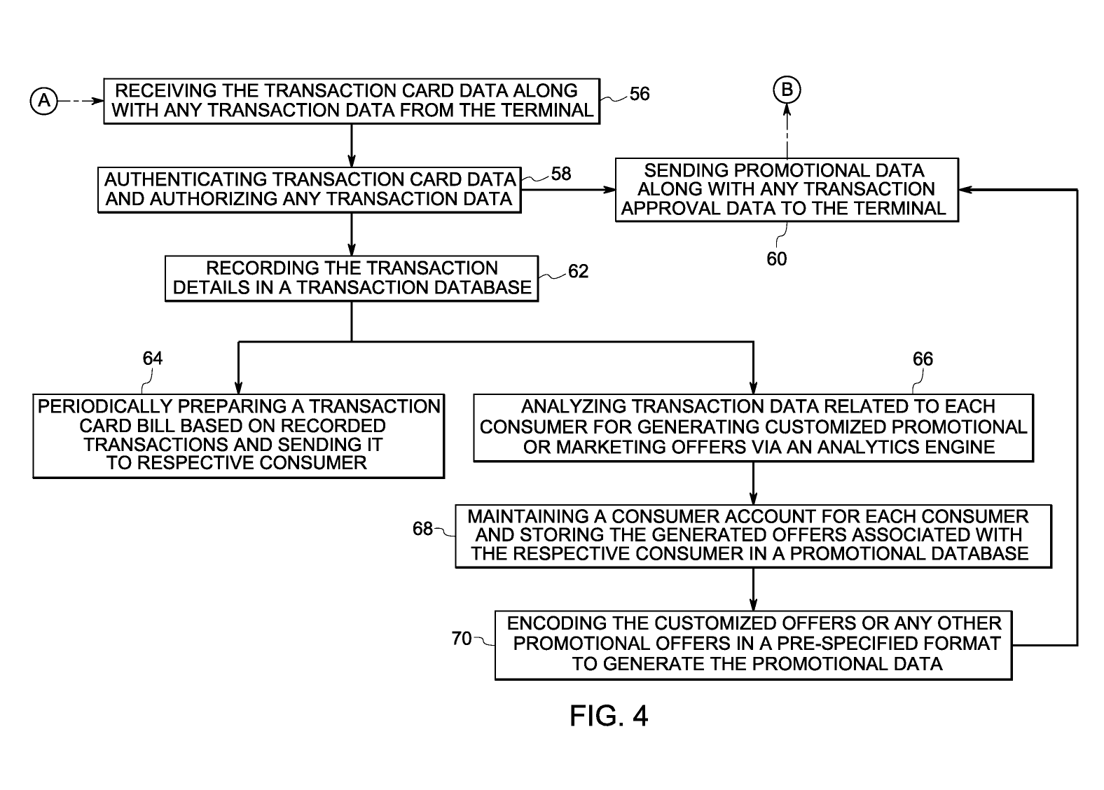

For example, referring now to FIGS. 3 through 4, exemplary control logic 40 for delivering the promotional or marketing offers to the consumer via a promotion delivery system, such as system 10, is depicted via a flowchart in accordance with aspects of the present technique. As illustrated in the flowchart, the control logic 40 includes the steps of reading transaction card data via a card read/write device upon presentation of the transaction card at the terminal at step 42, sending the transaction card data along with any transaction data to a transaction bank server at step 44, receiving promotional data along with any transaction approval data from the transaction bank server at step 46, and writing the promotional data on a transaction card via a card read/write device at step 48. Alternatively, the control logic 40 may include the steps of extracting one or more promotions available to the consumer from the promotional data at step 50, displaying the one or more available promotions as a selectable choice at step 52, and writing the selected promotions on the transaction card via the card read/write device or printing the selected promotions via a printer at step 54. As will be appreciated by one skilled in the art, the steps 42 through 54 of the control logic 40 are performed at the terminal end of the system 10.

The control logic 40 also includes the steps of receiving the transaction card data along with any transaction data from the terminal at step 56, authenticating transaction card data and authorizing any transaction data at step 58, and sending promotional data along with any transaction approval data to the terminal at step 60. Additionally, the control logic 40 includes the steps of recording the transaction details in a transaction database at step 62 and periodically preparing a transaction card bill based on recorded transactions for being sent to the respective consumer at step 64. Moreover, the control logic 40 includes the steps of analyzing current and/or past transaction data related to each consumer for generating customized promotional or marketing offers via an analytics engine at step 66, and maintaining a consumer account for each consumer and storing the generated offers associated with the respective consumer in a promotional database at step 68. It should be noted that the control logic 40 may also include the step of encoding the customized offers or any other promotional offers in a pre-specified format to generate the promotional data at step 70 before being sent to the terminal. As will be appreciated by one skilled in the art, the steps 56 through 70 of the control logic 40 are performed at the transaction bank server end of the system 10.

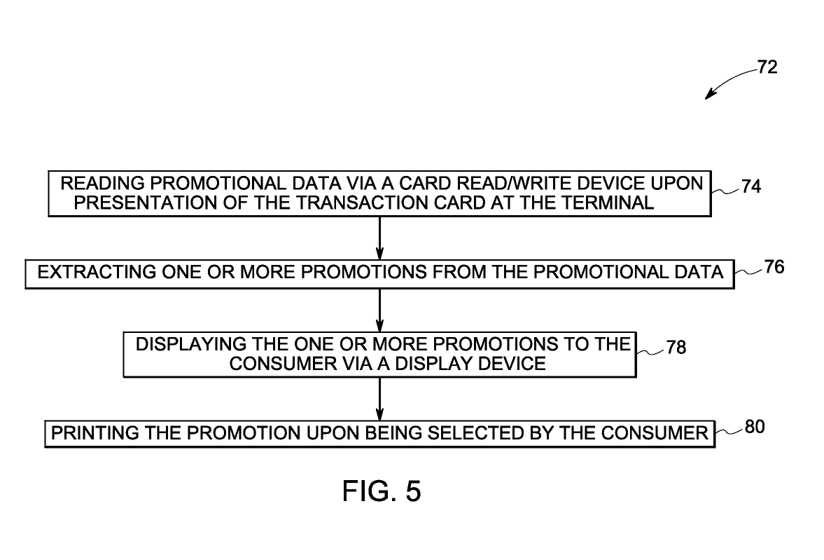

As will be appreciated by one skilled in the art, the promotional data written on the transaction card may also be accessed by the consumer from time to time. For example, referring now to FIG. 5, exemplary control logic 72 for displaying the promotional or marketing offers to the consumer via a promotion display system, such as terminal 12, is depicted via a flowchart in accordance with aspects of the present technique. As illustrated in the flowchart, the control logic 72 includes the steps of reading promotional data via a card read/write device upon presentation of the transaction card at the terminal at step 74, extracting one or more promotions from the promotional data at step 76, and displaying the one or more promotions to the consumer via a display device at step 78. Additionally, the control logic 72 may also include the step of printing the promotion upon being selected by the consumer at step 80.

As will be appreciated by one skilled in the art, the control logic 40 and 72 may enable the consumer to update/personalize the offers available to him/her from time to time. The consumer may view the offers written on his/her transaction card, access his/her account to view the offers available to him, compare the existing offers with the available offers, and update the list of existing offers by selecting the one or more available offers for being written on the transaction card either by appending the selected offer to list of existing offers or by replacing one of the existing offer with the selected offer. This may be achieved via a graphic user interface (GUI) on the terminal.

In order to make such customized promotional offers more useful to a customer, a system for the retailer can be used to generate and track the offers made, and the choices selected by the consumers. A promotion generator module, operated by the retailer or other business offering the promotion, can be used to generate a number of alternative promotions for the customer. This promotion generator module can use information received from selections made by previous customers, as well as other demographic and historical information in order to select the promotions that will be of most interest to the particular consumer who is choosing.

Information describing the promotions that will be offered to a particular consumer can then be sent to a promotion communicator. As discussed above, this can be an interactive kiosk, located at the point of sale or another promotional location, or done through a consumer's mobile phone, PDA, or home computer. The promotion communicator presents the options to the consumer, and allows the consumer to make one or more selections of the promotions that they would like. This information is then sent back to the promotion generator module for use in future analytics, and is also passed on to the promotion upgrader module, which works dynamically to upgrade the set of choices that are presented to consumers.

Another embodiment of such a system for providing customized promotions to a consumer can allow the customer to design the promotions that the customer wants to receive. This embodiment provides for a more personalized experience, and also provides important information to the marketers that allows them to track preferences by individual customer in order to provide a more specific and real-time form of market research.

One embodiment of such a system can be built using a number of intercommunicating modules. A promotion design module provides an interface through which a user can indicate what promotions they would like to have available. Such information is stored and can be sent to a back-end promotion server. The promotion server stores the aggregated data received from one or more promotion design modules, and can also be used to execute various analytic functions that provide statistical grouping and analysis of the desired promotions, broken down in various ways. Such analytics can be used to predict what promotions will be most successful when offered to particular groups of consumers.

A strategy module is used to capture business level inputs from a marketer that are sent to the back-end promotion server and are used to guide the analysis performed. These inputs are used to finalize the promotions that are going to be made available. These final promotion choices can then be sent to a offer delivery module that is linked to the promotion server that gives the customer information about the promotions that are being made available to him or her.

In another aspect of various embodiments described herein, a system and method for encoding promotional offers onto a transaction card or other writable customer token is used. This method includes reading information that identifies the customer from the card or token, and authenticating the customer with this information. The promotional offers specific to this customer can then be read from a marketing system. This system can either be locally disposed (if the offers are particular to a given location), or can be retrieved from a remote server across a communications network. An identifier for each promotion to be used can then be written to the card or token of the customer. As noted above, cards can be magnetic strip cards, such as credit/debit cards, PLCCs, loyalty cards and so forth, or may be cards with other storage embedded, such as a smart card. In addition to cards, tokens may take the form of RFID tags, flash-memory devices, or other non-volatile storage systems.

In addition to the methods and techniques described above, the use of a writable promotion card may also be part of a system that can be more effective at fraud detection. Such systems and techniques may make use of a “pre-purchase swipe” of a transaction card or other card. Because existing uses of charge cards and other types of card-payment systems only use a single swipe at the time of payment, any attempt to detect a fraudulent transaction must happen either immediately, or can only detect the fraudulent use after the fact. When techniques such as those described herein are used, the card will be used prior to the actual billing transaction in order to select promotional offers. By being swiped prior to the actual billing transactions, more opportunities for fraud detection are presented.

In one embodiment, the use of a swipe prior to the point of billing simply provides additional time for existing fraud detection schemes to operate. For instance, tracking patterns of usage is a known technique used to identify purchases or transactions that represent anomalies in the ordinary behavior of a particular consumer. Such out-of-the-ordinary usage may trigger the card issuer to take an action, such as calling the registered card holder to verify a transaction.

Another fraud detection technique that can take advantage of the additional time between a pre-billing swipe and a billing swipe is verifying the card number against lists of lost or stolen cards, which may take more time than is available in an ordinary billing transaction. Yet another technique can identify the location of the transaction to determine if the purchase pattern is consistent with the known behavior of the particular consumer. Such techniques can also be used to identify simultaneous use of the same card at geographically disparate locations.

At the time of the initial pre-billing swipe, and electronic token is generated for the card. The result of any fraud detection is sent back to the retailer and associated with the particular electronic token. At the time of a billing swipe, this token is used to identify any fraud that has been detected associated with the particular card, and can be used to prevent usage of the card, or to inform the retailer of the fraudulent usage and request that they confiscate the card.

In addition to being useful for fraud detection, a pre-billing swipe as described above may also be part of a system or technique to speed up transaction processing at the time of purchase. In ordinary card usage, the swipe of the card at the time of billing is used to read the information from the card, and to contact the card issuer to receive approval for the total amount of the transaction. During this communication and approval, time is wasted. Although such a delay may only be a few seconds per customer in the best cases, delays can be significantly longer during peak hours or if there are problems with the communication to the card issuer.

By having the opportunity to swipe their card before the actual time of transaction, the retailer can communicate a request for approval to a card issuer ahead of time, and receive a limit that would be approved for purchase at that retail outlet before such time as the transaction is actually ready to be processed. Such a system can make use of the electronic token and readers as described above for use with promotional selection. Such pre-billing swipes may also be done upon entry into a store. Because there is no need for the consumer to wait for any action at the time of such a pre-billing swipe, the amount of delay is minimized.

The card can be approved in advance of check-out for purchases up to a particular limit, and this limit can be communicated back to the retailer and associated with the electronic token for the particular card. At the time of check-out, the consumer will swipe their card again, enabling the system to identify the electronic token, and to determine whether or not the amount to be charged is within the pre-approved amount. If it is, the charge can be approved immediately, and without waiting for a communication back to the card issuer. The amount of the transaction will need to ultimately be communicated to the card issuer, but because there is no need to wait for approval, such actual charge information can be done in batches or with a delay, but without incurring any delay to the processing of a particular customer. This technique will allow the check-out process to move more quickly, especially during times of peak load on the communication network. If the amount charged exceeds the pre-approved limit, then an ordinary approval can be processed as normal at the time of check-out.

Such techniques and systems may be of especial use for businesses that already make use of reward or membership cards. In such businesses, reading the information from such cards is already a separate process from billing. For example, when entering a “member's only” club store, a customer generally has to show or swipe their card anyway. Similarly, if you belong to a “frequent buyer's club” at a store, such as a book store, entry of a membership number or swipe of a membership card is required in order to get the benefits associated with your membership. By allowing these swipes to take place upon entry to a store, and by allowing them to also be used for swiping a payment card, the entire check-out process can be made faster and less dependent on real-time communication to a back-end server. Such techniques also allow for identifying additional tracking information related to the frequency of consumers entering a store, and then not making a purchase.

The promotion system and techniques as described in various embodiments discussed above provide an efficient and effective way of delivering various promotional or marketing offers to the consumer so as to increase the sales and revenue. For example, the availability of promotional offers at the time of processing a transaction will increase the probability of usage of these offers, thereby increasing the volume of transactions and sales revenue. Additionally, the ability to customize promotional offers for each user via the back end analytics system will increase the effectiveness of the promotions. Further, the techniques allow a business entity (retailer or financier) to provide a choice to its customer to select and personalize various offers of interest. This will enhance the capability of business entities to capture consumer preferences and to personalize the promotions based on their preferences for target marketing. Moreover, the techniques enable the consumers to view, select, upgrade, or use their entitled offers at their convenience resulting in increased effectiveness of the promotions.

As will be appreciated by one skilled in the art, the techniques as described in various embodiments discussed above provide promotions to the consumers via transaction cards, thereby facilitating the use of transaction cards as active marketing or promotion media. This will enable the promoters to store dynamic promotional as well as customized marketing and promotional offers on the transaction card of the consumer. Marketing and promotional offers can be in made electronic form, thereby reducing or eliminating the traditional and more expensive print based promotion techniques and wastage associated with them. Additionally, promotional values can be netted against transaction values electronically and immediately.

While only certain features of the invention have been illustrated and described herein, many modifications and changes will occur to those skilled in the art. It is, therefore, to be understood that the appended claims are intended to cover all such modifications and changes as fall within the true spirit of the invention.

1. A system for delivering promotions to a consumer, the system comprising:
a transaction bank server configured to send promotional data containing one or more promotions to a terminal over a communication channel, the terminal comprising a card read/write device configured to write the promotional data on a transaction card.

2. The system of claim 1, wherein the communication channel comprises at least one of a wired communication network, a wireless communication network, and a portable memory device.

3. The system of claim 1, wherein the transaction bank server is further configured to receive a transaction card data, or a transaction data, or a combination thereof from the terminal over the communication channel.

4. The system of claim 3, wherein the transaction card data is read from the transaction card via the card read/write device.

5. The system of claim 3, wherein the transaction bank server is further configured to perform an authentication of the transaction card data, or an authorization of the transaction data.

6. The system of claim 5, wherein the transaction bank server is further configured to send a transaction approval data to the terminal over the communication channel based on the authentication and the authorization.

7. The system of claim 1, wherein the one or promotions comprises a discount coupon, a cash back offer, a product discount, a credit card APR discount, a reward point based promotion, or a loyalty point based promotion.

8. The system of claim 1, wherein the one or more promotions are uniquely encoded in a pre-specified format within the promotional data.

9. The system of claim 1, wherein the one or more promotions are customized for the consumer.

10. The system of claim 9, wherein the transaction bank server is further configured to perform an analysis on the consumer behavior based on a current and/or a past transaction data to generate the one or more customized promotions.

11. The system of claim 1, wherein the transaction bank server is further configured to maintain a consumer account for each consumer to store the one or more promotions associated with the respective consumer.

12. The system of claim 11, wherein the consumer account is accessible by the respective consumer through the terminal via the transaction card or a login information to view, select, and upload the one or more available promotions.

13. The system of claim 1, wherein the terminal is a POS terminal, or a transaction terminal, or a kiosk, or a mobile device, or an ATM, or a computer terminal.

14. The system of claim 1, wherein the terminal further comprises a display device configured to display the one or more promotions written on the transaction card, or the one or more promotions sent from the transaction bank server.

15. The system of claim 14, wherein the one or more promotions sent from the transaction bank server is displayed as a selectable choice.

16. The system of claim 15, wherein the card read/write device is configured to write the one or more promotions on the transaction card upon being selected by the consumer.

17. The system of claim 14, wherein the terminal further comprises a printer configured to print the one or more promotions written on the transaction card or the one or more promotions sent from the transaction bank server upon being requested by the consumer.

18. The system of claim 1, wherein the transaction card comprises a card having a data storage medium.

19. The system of claim 1, wherein the transaction card comprises a magnetic stripe card, or a RFID card, or an optical card, or a smart card.

20. The system of claim 19, wherein the transaction card comprises a magnetic stripe card and the promotional data is written on at least one of a plurality of read/write tracks of the magnetic stripe card.

21. The system of claim 1, wherein the transaction card comprises a debit card, or a credit card, or a PLCC card, or a bank card, or a loyalty card, or a reward card.

22. A method of delivering promotions to a consumer, the method comprising:
receiving a transaction card data from a terminal over a communication channel on presentation of a transaction card at the terminal;
performing an authentication of the transaction card data;
sending a promotional data containing one or more promotions to the terminal over the communication channel; and
writing the promotional data on the transaction card via a card read/write device.

23. The method of claim 22, wherein receiving the transaction card data comprises reading the transaction card data via the card read/write device.

24. The method of claim 22, further comprising receiving a transaction data from the terminal over the communication channel.

25. The method of claim 24, further comprising performing an authorization of the transaction data.

26. The method of claim 25, further comprising sending a transaction approval data to the terminal over the communication channel based on the authentication and the authorization.

27. The method of claim 22, further comprising uniquely encoding the one or more promotions in a pre-specified format within the promotional data.

28. The method of claim 22, further comprising customizing the one or more promotions for the consumer.

29. The method of claim 28, wherein customizing the one or more promotions comprises performing an analysis on the consumer behavior based on a current and/or a past transaction data to generate the one or more customized promotions.

30. The method of claim 22, further comprising maintaining a consumer account for each consumer to store the one or more promotions associated with the respective consumer.

31. The method of claim 30, further comprising providing access to the consumer to the respective consumer account through the terminal via the transaction card or a login information to view, select and upload the one or more available promotions.

32. The method of claim 22, further comprising displaying the one or more promotions written on the transaction card, or the one or more promotions sent from the transaction bank server, or a combination thereof.

33. The method of claim 32, wherein displaying the one or more promotions sent from the transaction bank server comprises displaying the one or more promotions sent from the transaction bank server as a selectable choice.

34. The method of claim 33, wherein writing the promotional data on the transaction card comprises writing the one or more promotions on the transaction card upon being selected by the consumer.

35. The method of claim 22, further comprising printing the one or more promotions written on the transaction card or the one or more promotions sent from the transaction bank server upon being requested by the consumer.

36. The method of claim 22, wherein writing the promotional data on a transaction card comprises writing the promotional data on one of the available read/write tracks of the magnetic stripe card.

37. A method of delivering promotions to a consumer, the method comprising:
sending a transaction card data to a transaction bank server over a communication channel on presentation of a transaction card at the terminal;
receiving a promotional data containing one or more promotions from the transaction bank server over the communication channel upon an authentication of the transaction card data by the transaction bank server; and
writing the promotional data on the transaction card via a card read/write device.
